(19) United States
(12) Patent Application Publication
(10) Pub. No.: US 2008/0173687 A1
(43) Pub. Date: Jul. 24, 2008

(54) Method and device for breaking thin glass sheets

(75) Inventor: Bernd Christoph Hoetzel, Worrstadt (DE)

Correspondence Address: FLASTER/GREENBERG P.C.;8 PENN CENTER, 1628 JOHN F. KENNEDY BLVD., 15TH FLOOR, PHILADELPHIA, PA, 19103, US

(73) Assignee: MDI SCHOTT Advanced Processing GmbH, Mainz (DE)

(21) Appl. No.: 12/004,186

(22) Filed: Dec. 20, 2007

(30) Foreign Application Priority Data
Jan. 5, 2007 (DE) 102007001133.6-45

(51) Int. Cl. B26F 3/00

(52) U.S. Cl. 225/2; 225/96

(57) ABSTRACT

A method and a device are described to break thin glass sheets, especially compound and sandwich sheets (double sheets) in which the scratched glass is placed scratched side down on a glass cutting table that is provided with an elastic cover. The sheets are fixed to the glass cutting table by means of a vacuum, and they are broken by applying pressure to the unscratched side with a cutter. The elastic cover has a Shore A hardness of 60 to 100 and a rebound resilience according to DIN 53 512 of 35% to 70%.

### BACKGROUND OF THE INVENTION

1. Field of the Invention

The invention relates to a method and a device for breaking thin glass sheets, especially sandwich sheets (double sheets) for liquid crystal display devices.

2. Description of Related Art

Thin glass sheets are primarily used in liquid crystal display devices. For this purpose, the large glass sheets produced in a glass drawing system (such as a float glass system) are divided into smaller units of a desired size for use.

Furthermore, sheets that are provided with numerous liquid crystal display cells are cut into individual liquid crystal display cells.

The dividing (breaking) of glass sheets generally occurs in two steps. In the first step, a controlled defect or flaw such as a notch is created in the glass sheet, and the flaw is expanded in the second step to divide the glass. The flaw can be created by any desired means that introduces or generates a crack. The flaw can be generated as a scratch with a diamond or a glass cutter, or a stress line with a laser beam. The flaw is then usually extended by bending the glass while exerting stress until the glass sheet breaks.

A method is known from JP 63-166734 for cutting thin glass in which a glass sheet with a scratch line is positioned on a breaking table and affixed there by means of a vacuum. An elastic plate is placed between the glass sheet and breaking table. Pressure is exerted from above on the scratch line in the glass sheet by means of a hydraulic element, and the sheet is divided along the scratch line.

JP 04 238827 A describes a device for dividing glass substrates for liquid crystal cells. The glass substrate is placed on a breaking table with the scratched side face down, it is held there with a vacuum, and it is broken by the high pressure from above on the dividing line.

JP 2004131341 A also describes the division of glass, especially sandwich-like glass substrates with a plurality of liquid crystal cells. Just as in JP 04 238827 A, the substrates are sandwich like. The substrate is scratched and then placed on a rubber plate with the scratch face down. Between the rubber plate and the glass, there is another plate made of iron or stainless steel to protect the rubber plate from wear and surface damage. Due to its smooth surface, it also serves to protect the glass from sticking to the rubber layer from excessive adhesion since this reduces the quality of the cut and can produce waste.

Other devices are also known that, instead of a plate of stainless steel, have a layer of porous fluoropolymer (such as polytetrafluoroethylene (PTFE), fluorinated ethylene-propylene copolymer (FEP), perfluoralkoxy resin (PFA), ethylene-tetrafluoroethylene copolymer (ETFE), polyvinyl fluoride (PVF), polyvinylidene fluoride (PVDF), chlorotrifluoroethylene-vinylidene fluoride copolymer, ethylene-chlorotrifluoroethylene copolymer (ECTFE), etc.). The layer can be an open-pore sintering film, a porous sintering plate, fleece, fabric, etc. The fluoropolymer can also be used in addition to the metal plate to prevent contact between the glass and metal plate. The glass substrate is affixed to the glass cutting table by means of a vacuum. For this purpose, the rubber plate as well as the metal plate and fluoropolymer are provided with openings through which the vacuum can act on the glass substrate.

It has been shown, however, that this breaking method does not always produce satisfactory results especially when two cuts directly adjacent to each other have to be made in sandwich glass sheets (double sheets). Such cuts are necessary to separate large arrays of liquid crystal cells into the individual cells, that is, to isolate them, and the individual cells have the shape after the cutting procedure shown for example, in JP 04 23827, FIG. 6.

### BRIEF SUMMARY OF THE INVENTION

The problem of the invention is to find a method as well as a device for breaking thin glass sheets, especially sandwich sheets, by means of which the sheets can be cleanly broken especially when the cuts are close to each other, and less waste is produced.

This problem is solved by means of the claimed method as well as the claimed device.

It was found that the key to improving the results lies in the elastic base for the sheet to be cut.

If an elastomer base is used with a hardness of 60 to 100 Shore A and a rebound resilience of 35% to 70% in accordance with DIN 53 512, the results are improved. It is preferable when the base has a Shore A hardness of 70 to 90 and/or a rebound resilience according to DIN 53 512 of 40% to 60%.

### BRIEF DESCRIPTION OF THE SEVERAL VIEWS OF THE DRAWING(S)

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. The invention will be further explained with reference to the drawings. The drawings show:

FIG. 1 Shows a sandwich sheet arrangement (double sheet) with 36 TFT cells that need to be isolated;

FIG. 2 Schematically shows a breaking table with a mounted and scratched TFT array; and

FIG. 3 Shows a section of an isolated TFT cell.

### DETAILED DESCRIPTION OF THE INVENTION

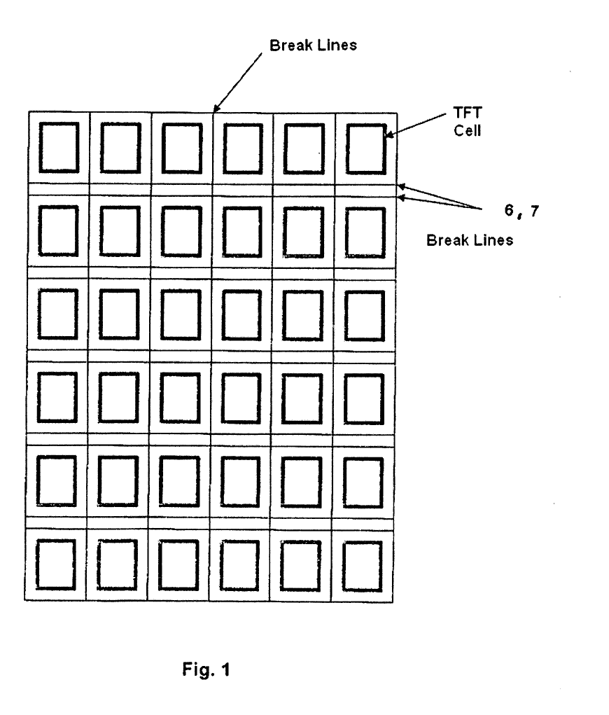

FIG. 1 schematically illustrates a top view of the CF glass side of a sandwich arrangement comprising two sheets that contains an array of 36 individual liquid crystal cells. Smaller liquid crystal cells are not individually compiled for manufacturing reasons. Instead, a plurality of individual liquid crystal cells is produced between two large sheets that presently measure up to 120×120 cm².

The liquid crystal cells or the array comprising a plurality of sheets comprises a sheet that bears the electrical devices for controlling the liquid crystals such as thin-film transistors (TFT) and the electrical supply conductors, and a cover sheet made of CF glass (CF=color filter). Individual liquid crystal cells such as TFT cells are between the sheets, and the cell dimensions are formed by the wide dark edges of the individual cells. These edges simultaneously adhere the two sheets and seal the cells holding the liquid crystals against the environment. FIG. 1 shows a top view of the CF side with the provided scratch or break lines.

The array is individualized into individual cells in several steps. First, the CF side is scratched corresponding to the provided break lines. This can in principle be done in any manner, especially with a cutting diamond or glass cutter. The thin glass and sandwich sheets (compound sheets) to be scratched that bear the arrays of liquid crystal cells used are thin glass less than 1.2 mm thick, and especially 0.2 to 1.1 mm. In the liquid crystal cells, the sheets are approximately 0.004 to 0.015 mm from each other.

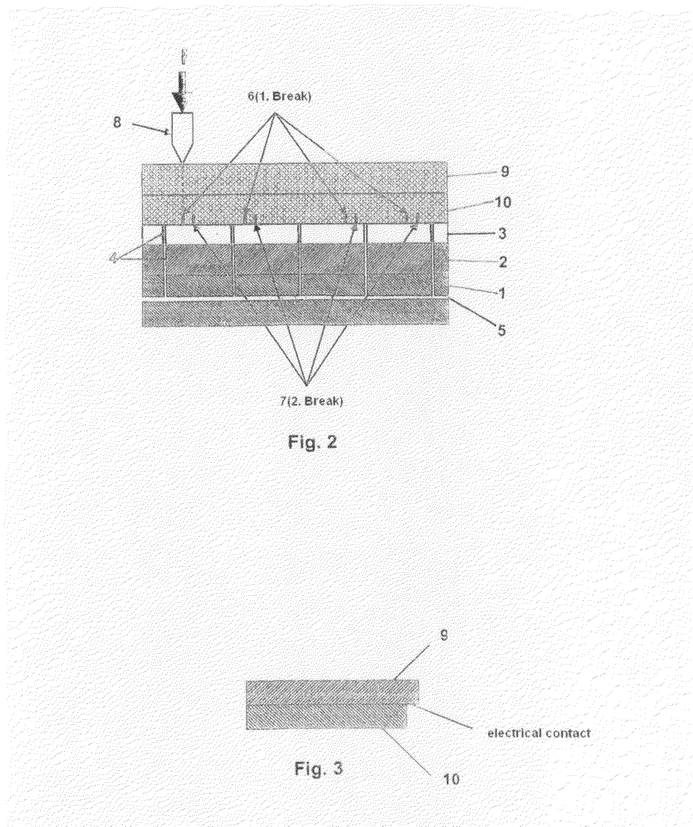

After being scratched, the compound sheets are rotated, and the scratched side is placed downward on the glass cutting table. A section of a glass cutting table with the compound glass sheets on top of it is schematically portrayed in FIG. 2.

The breaking table comprises a flat, non-distorted metal plate 1 on which the elastomer plate, the so-called breaking rubber 2, is located. The plate 2 is 1 to 5 mm thick and preferably 2 to 4 mm thick. When the plate is thicker than 5 mm, there is no additional positive effect, and the cost of the elastomer increases. When the plate is thinner than 1 mm, the separating results can be worse since the elastic deformation is no longer sufficient. For a good separating result, it is also advantageous when the surface of the breaking rubber is very flat. As a reference point, good results can be achieved when the planarity of the surface, such as the deviation in thickness or waviness, is preferably 0.1 mm or less, and especially 0.02 to 0.06 mm. A deviation of up to 0.2 mm is generally still useful when the length of the undulation of the deviation is large enough, i.e., when the glass can follow the surface fluctuations due to its flexibility. Larger surface fluctuations are also tolerable. In an individual case, a person skilled in the art can easily determine in a preliminary test if the use of the provided elastomer panel with its special material properties produces satisfactory results together with the glass plate to be cut. To achieve good breaking results, it is advantageous when the sheet has particularly good planarity and the breaking rubber is very hard. For example with a Shore A hardness of 90, the deviation of the planarity is approximately 0.02 to 0.05 mm. Due to its favorable mechanical properties and the high wear resistance, a polyurethane elastomer is preferred for the elastic base (breaking rubber). Such PUR-elastomers are for example producible by means of polyaddition from polydiols or polyesters and diisocyanates, and are offered by numerous manufacturers. The products marketed under the brand name of Vulkollan® are particularly familiar.

Between the elastic layer and the glass (compound) sheet comprised of the TFT sheet 9 and CF sheet 10, a layer of fluoropolymer 3 is inserted in a known manner. A high-grade steel sheet can also be used. It is however preferable to use a layer of fluoropolymer that is known from the prior art, especially a layer of polytetrafluoroethylene.

The elastomer plate is provided with holes 4, and likewise the fluoropolymer layer, or an open-pore layer or fabric is used. A vacuum can be applied to the glass plate on top by means of corresponding supply lines 5 in the metal plate 1.

After the glass plate is fixed to the breaking table by means of a vacuum, a pressure F is exerted in a known manner on the glass plate with a cutter 8 opposite the scratch lines 6 and 7 which causes the scratched glass plate to break along the scratch line. The cutter can be provided in a known manner with a fluoropolymer coating such as a fabric to protect the glass and cutter. In the case of compound sheets, the other glass sheet is subsequently scratched, the sandwich sheet is turned over so that the scratched sheet lies on the breaking table scratch side down, and this sheet is also broken from the pressure of the cutter.

After both sheets of the compound sheets are broken, the individual displays can be separated.

An individual display is shown in FIG. 3. The display consists of the cover glass (CF glass) 10 and the TFT glass 9 by means of which the liquid crystals are controlled. The TFT glass projects slightly in relation to the CF glass. This allows the electrical conductors of the cell on the TFT glass to be electrically connected to the rest of the control electronics.

Due to the frequently limited availability of space for a display, it is important to keep the usable area of the display as large as possible, i.e., the edges available for the electrical contacts should be kept as small as possible. The two cuts in the CF glass therefore need to be as close to each other as possible. The present method and device make it possible to reliably create clean cuts with a greater yield when the cut lines are only 1.5 to 2 mm apart.

### EXAMPLE

On a breaking table measuring 100×100 cm², 50 compound glass sheet arrays containing 400 liquid crystal cells were divided into individual cells (individualized).

The breaking table was provided with a 100×100 cm² polymer plate, 3 mm thick, made of a polyurethane (PU) elastomer based on polyester polyol and naphthalene-1,5-diisocyanate (NDI) that for example is commercially available under the name of Vulkollan® D15. The polyurethane elastomer had a Shore A hardness of 70 and a rebound resilience according to DIN 53 512 of 45%. The deviation in planarity was 0.03±0.02 mm. The elastomer layer was covered with a 0.5 mm thick porous PTFE film. The film serves to protect the PU plate and can be easily changed. The PU plate was provided with holes through which a vacuum could be applied to fix the glass sheet to the glass plate.

The first side of the compound sheets was scratched, and the scratched side was placed on the breaking table, then fixed by means of a vacuum, and the scratched sheet was broken with a cutter in a known manner. Then the other side of the compound glass sheet was scratched, the compound glass sheet was turned over, the scratched side was placed on the breaking table, and the second sheet of the compound glass sheet was broken.

Individual liquid crystal cells were created that for example are shown in FIG. 3.

From the 50 compound glass sheet arrays, 400 flawless liquid crystal cells were created corresponding to a yield of 100%.

### COMPARATIVE EXAMPLE

The example was repeated with the same number of identical compound glass sheet arrays. The only difference was that a plate was used consisting of NBR elastomer with a Shore A hardness of 70 and a rebound resilience according to DIN 53 512 of 20% instead of the PU plate. From the compound glass sheets, 320 flawless liquid crystal displays were created corresponding to a yield of 80%.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. A method to break thin glass sheets, especially sandwich sheets, wherein the sheet to be broken is scratched, the scratched side is placed on a breaking table with an elastic base and fixed thereto by means of a vacuum, then pressure is exerted on the unscratched side of the sheet opposite the scratch line by means of a cutter which causes the sheet to break along the scratch line, wherein an elastic base having a Shore A hardness of 60 to 100 and a rebound resilience according to DIN 53 512 of 35% to 70% is used.

2. The method according to claim 1, wherein the elastic base is used with a Shore A hardness of 70 to 90.

3. The method according to claim 1, wherein the elastic base is used with are bound resilience according to DIN 53 512 of 40% to 60%.

4. The method according to claim 1, wherein the elastic base is used with a thickness of 1 to 5 mm.

5. The method according to claim 1, wherein the elastic base is used with a maximum deviation in planarity of 0.2 mm on its side facing the glass.

6. The method according to claim 5, wherein the elastic base is used with a maximum deviation of 0.1 mm on its side facing the glass.

7. The device to break thin glass sheets, especially sandwich sheets comprising a breaking table to bear the glass sheet, wherein the breaking table has an elastic cover for facing the side of the glass sheet with a scratch line, wherein the elastic cover has openings for applying a vacuum to fix the glass sheet, and a pressure part (cutter) at a distance above the table for exerting pressure on the glass sheet, wherein the elastic cover comprises an elastomer and has a Shore A hardness of 60 to 100 and a rebound resilience according to DIN 53 512 of 35% to 70%.

8. The device according to claim 7, wherein the elastic cover has a Shore A hardness of 70 to 90.

9. The device according to claim 7, wherein the elastic cover has a rebound resilience according to DIN 53 512 of 40% to 60%.

10. The device according to claims 7, wherein the cover is 1 to 5 mm thick.

11. The device according to claim 10, wherein the cover is 2 to 4 mm thick.

12. The device according to claim 7, wherein the planarity of the side of the cover facing the glass sheet deviates less than 0.2 mm.

13. The device according to claim 12, wherein the planarity of the side of the cover facing the glass sheet deviates less than 0.1 mm.
